(19) United States
(12) Patent Application Publication
(10) Pub. No.: US 2013/0327906 A1
(43) Pub. Date: Dec. 12, 2013

(54) FURNITURE STRUCTURE TO HOLD BEVERAGE CONTAINERS

(71) Applicants: Lausan Chung-Hsin LIU, Shanghai (CN); Shopo Hsin Tsu Liu, Shanghai (CN); Fibro Tsu Kun Liu, Shanghai (CN)

(72) Inventors: Lausan Chung-Hsin LIU, Shanghai (CN); Shopo Hsin Tsu Liu, Shanghai (CN); Fibro Tsu Kun Liu, Shanghai (CN)

(21) Appl. No.: 13/494,619

(22) Filed: Jun. 12, 2012

(51) Int. Cl. F16M 13/02

(52) U.S. Cl. 248/205.1

(57) ABSTRACT

A furniture structure to hold beverage containers comprises a furniture body, a beverage container holding rack and a fastening element to fasten the beverage container holding rack to the furniture body. The beverage container holding rack includes a base, a retaining body and a carrying body hinged on the base and retaining body. The carrying body includes a carrying plane exposed upon flipping against the base. The retaining body includes a confining plane exposed upon flipping against the carrying body. The base, carrying plane and confining plane jointly form a housing space to hold a beverage container. Thereby the problem of the conventional beverage container holding rack mounted onto the furniture body can be solved.

### FIELD OF THE INVENTION

The present invention relates to a furniture structure and particularly to a furniture structure to hold beverage containers.

### BACKGROUND OF THE INVENTION

People living in modern time often have to bear of lot of stress. How to release the stress is an important issue. Many types of channels and programs have been offered to help people to release the stress, amount them outdoor activities are very effective and enjoyed by many people. By embracing the nature such as mountain hiking or relaxing in scenic sites people often can get serene mind and unwind from the stress of life or work.

Many people like to carry a piece of outdoor furniture during outdoor activities, such as a chair, a lounge chair or the like for resting during the activities. They also often bring drinks with them to quench thirst whenever needed. The unfinished drinks often are put on the ground around the furniture so that they can be easily fetched and drank next time. This often results in incidental toppling of the drinks caused by inadvertence of people. It creates unnecessary waste and costs that people need to spend extra expense buying the drinks again.

To solve the aforesaid problem, some outdoor furniture is equipped with a holding portion to hold beverage containers. But most outdoor furniture does not have such a design. People have to install by themselves an extra beverage container holding rack for this purpose. The beverage container holding rack now on the market usually is made in a fixed style. Moreover, most outdoor furniture is not being designed with the consideration of adding the beverage container holding rack. Hence when the outdoor furniture is folded the added beverage container holding rack could hinder folding, or jut outside the furniture after folding and create problems in storing of the outdoor furniture. Moreover, the conventional beverage container holding rack made in one fixed style also cannot accommodate many other beverage containers of different sizes.

### SUMMARY OF THE INVENTION

The primary object of the present invention is to provide a furniture structure to hold beverage containers.

To achieve the foregoing object, the furniture structure according to present invention comprises a furniture body, a beverage container holding rack and a fastening element to fasten the beverage container holding rack to the furniture body. The furniture body includes at least one support portion and an assembly hole formed on the support portion. The beverage container holding rack includes a base, a retaining body and a carrying body hinged on the base and retaining body. The base includes a first pivotal portion connected to the carrying body and an assembly portion corresponding to the assembly hole. The carrying body includes a second pivotal portion connected to the retaining body and a carrying plane exposed upon flipping against the base. The retaining body includes a confining plane exposed upon flipping against the carrying body. The base, carrying plane and confining plane jointly form a housing space to hold a beverage container. The fastening element is fastened to the assembly hole and has a fastening portion on one side opposing to the assembly hole to fasten to the assembly portion.

In one embodiment the base has a first latch portion connected to the assembly portion, and the retaining body has a second latch portion corresponding to and latchable with the first latch portion.

In another embodiment the first pivotal portion has a first elastic element to provide an elastic action force for the base.

In yet another embodiment the second pivotal portion has a second elastic element to provide an elastic action force for the carrying body.

In yet another embodiment the base has a first barrier wall extended into the housing space.

In yet another embodiment the carrying body has a retaining wall extended into the housing space.

In yet another embodiment the retaining body has a second barrier wall extended and perpendicular to the carrying plane.

In yet another embodiment the carrying plane has at least one drain port.

In yet another embodiment the retaining body has an elastic butting plate connecting to the confining plane.

In yet another embodiment the base has a first leaning portion leaned by the carrying body to prohibit the carrying body from flipping, and the carrying body has a second leaning portion leaned by the retaining body to prohibit the retaining body from flipping.

In yet another embodiment the fastening portion of the fastening element is a dovetail groove and the assembly portion coupled on the beverage container holding rack is a dovetail.

By means of the structure set forth above, the beverage container holding rack can be constructed with the base, carrying body and retaining body pivotally connected so that the carrying body can flip against the base and the retaining body can flip against the carrying body. After the aforesaid elements have been flipped the beverage container holding rack can be changed in structural forms. Compared with the conventional beverage container holding rack that provides only one fixed style and cannot be changed in response to requirements, the invention provides the beverage container holding rack that can be folded for storage and quickly removed from the furniture body as required, thus resolves the storage problem of the conventional beverage container holding rack.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of an embodiment of the invention.

FIG. 2 is a perspective view of the beverage container holding rack according to the invention.

FIG. 3 is an exploded view of the beverage container holding rack according to the invention.

FIG. 4 is a rear perspective view of the beverage container holding rack according to the invention.

FIG. 5A is a schematic view of the beverage container holding rack of the invention in a folding and storage state.

FIG. 5B is a schematic view of the beverage container holding rack of the invention in flipping operation-1.

FIG. 5C is a schematic view of the beverage container holding rack of the invention in flipping operation-2.

FIG. 5D is a schematic view of the beverage container holding rack of the invention in a flipping finished condition.

### DETAILED DESCRIPTION OF THE PREFERRED EMBODIMENTS

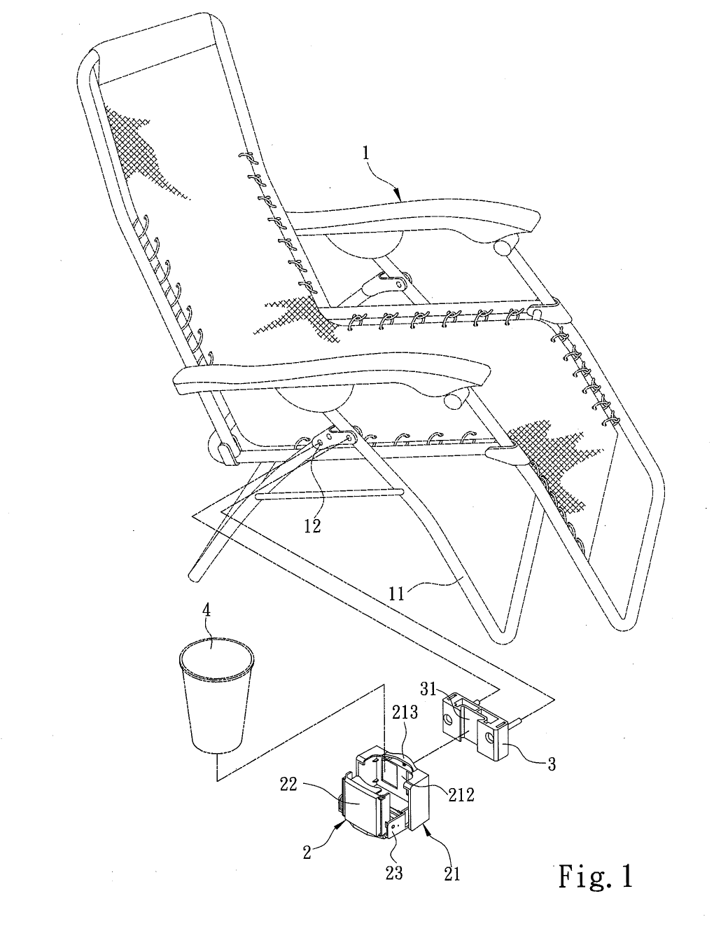

Please refer to FIG. 1 for an embodiment of a furniture structure to hold beverage containers. It comprises a furniture body 1, a beverage container holding rack 2 and a fastening element 3 to hold a beverage container 4. The furniture body 1 includes at least one support portion 11 and an assembly hole 12 formed on the support portion 11. The furniture body 1 can be a piece of outdoor furniture, such as a chair, lounge chair or the like. FIG. 1 illustrates a chair as an example of the embodiment, but this is not the limitation of the invention.

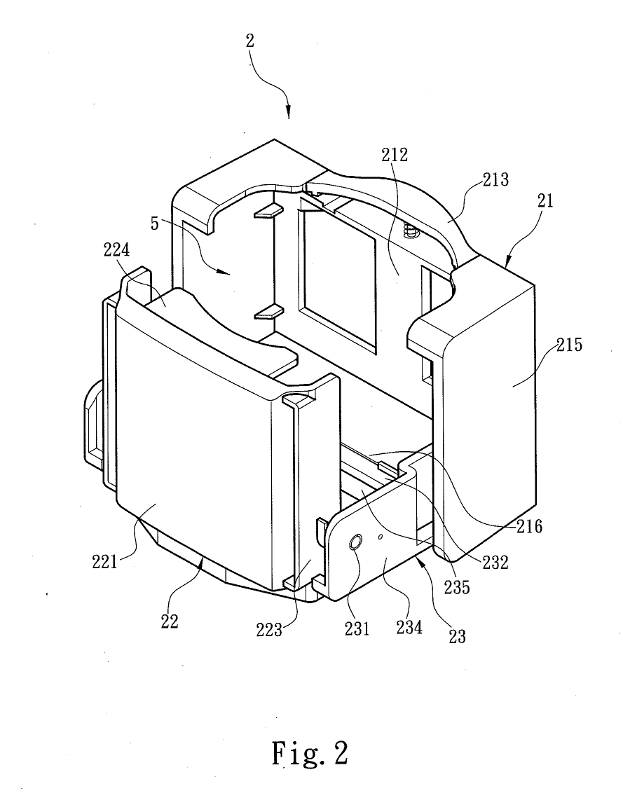

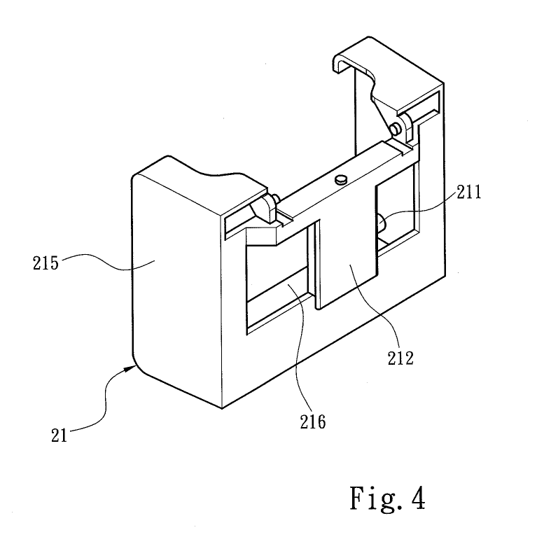

Also referring to FIGS. 2, 3 and 4, the beverage container holding rack 2 includes a base 21, a retaining body 22 and a carrying body 23 hinged on the base 21 and retaining body 22. The base 21 includes a first pivotal portion 21 connected to the carrying body 23 and an assembly portion 212 corresponding to the fastening element 3. The carrying body 23 includes a second pivotal portion 231 connected to the retaining body 22 to allow the retaining body 22 to flip against the carrying body 23, and the carrying body 23 can flip against the base 21. The fastening element 3 is fastened to the assembly hole 12 and has a fastening portion 31 on one side opposing to the assembly hole 12 to fasten to an assembly portion 212 of the beverage container holding rack 2. The fastening element 3 can be fastened to the support portion 11 through a retaining element such as a rivet or screw. The fastening portion 31 can be a dovetail groove, and the assembly portion 212 coupled with the fastening portion 31 can be a mating dovetail. When the assembly portion 212 and the fastening portion 31 are coupled together the beverage container holding rack 2 is confined by the fastening element 3 and held on the furniture body 1. In the event that to remove the beverage container holding rack 2 from the furniture body 1 is desired, it can be accomplished by separating the assembly portion 212 and the fastening portion 31 without relying on hand tools.

To limit the carrying body 23 to flip within a selected displacement, the base 21 further has a first leaning portion 216 to be leaned by the carrying body 23 after it has flipped against the base 21 for the selected displacement, and the carrying body 23 has a carrying plane 232 exposed. The carrying body 23 also has a second leaning portion 236 to limit the retaining body 22 to flip within a selected displacement so that the retaining body 22 can flip against the carrying body 23 only within a selected displacement, and the retaining body 22 has a confining plane 221 exposed upon leaning on the carrying body 23. Thereby the base 21, carrying plane 232 and confining plane 221 jointly form a housing space 5 to hold the beverage container 4.

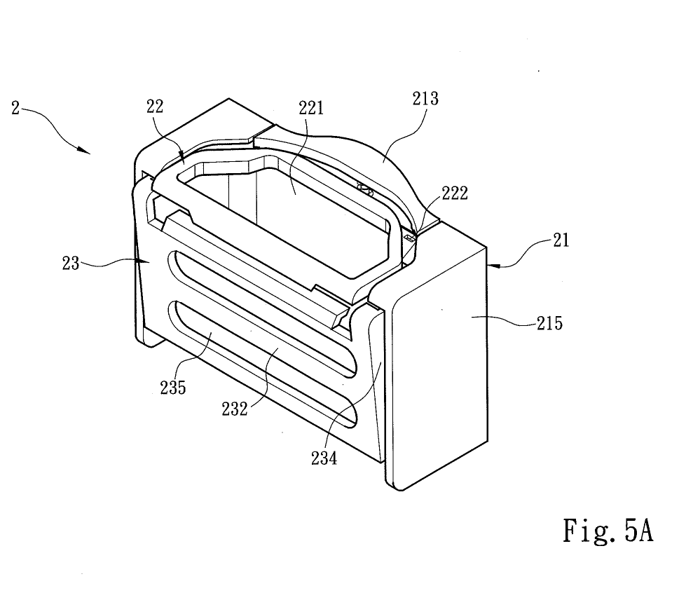

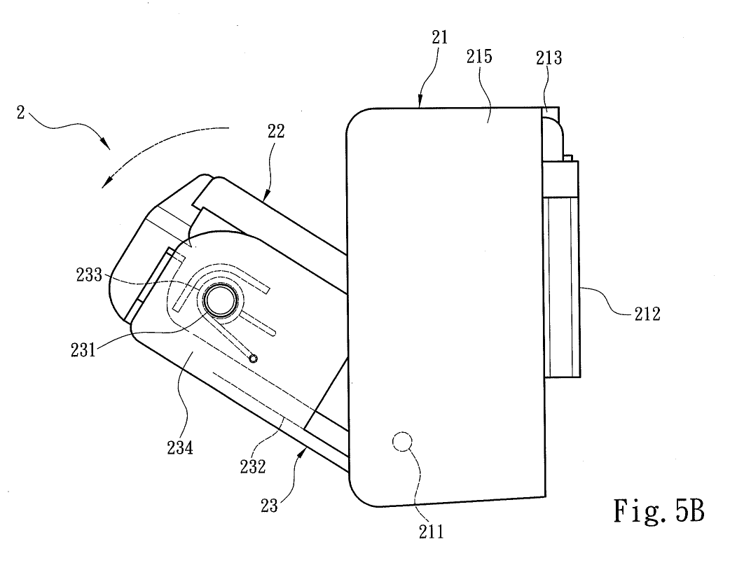

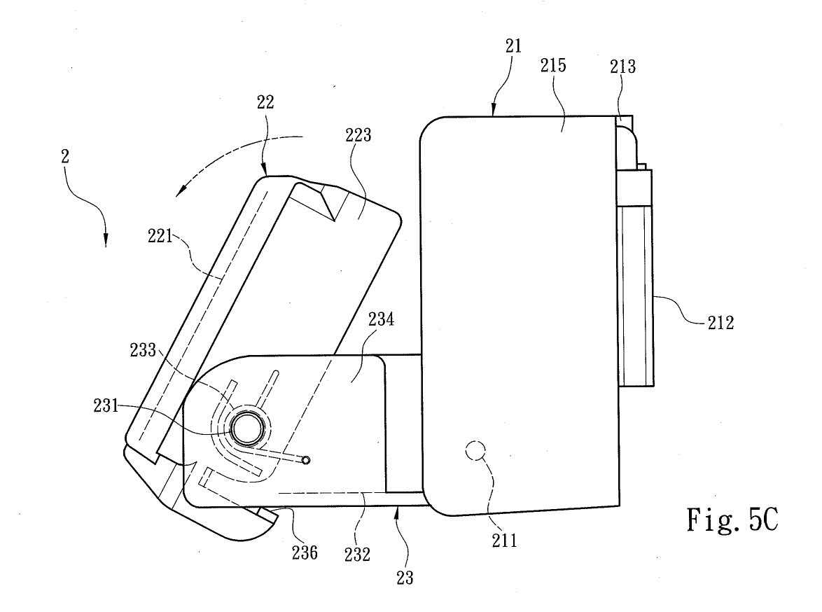

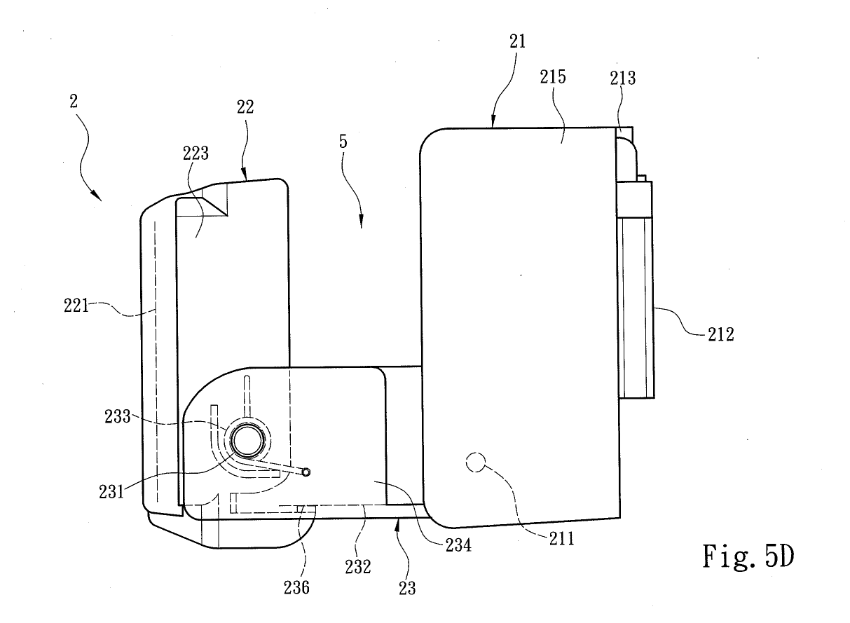

Referring to FIG. 5A, when the beverage container holding rack 2 is not in use the retaining body 22 is not flipped against the carrying body 23, hence is stacked over the carrying body 23. The carrying body 23 also is not flipped against the base 21, hence is stacked over the base 21, therefore the retaining body 22 is interposed between the base 21 and carrying body 23, and the beverage container holding rack 2 is in a folding and storage state. Referring to FIG. 5B, when unfolding the beverage container holding rack 2 is desired to hold the beverage container 4, the carrying body 23 is pulled to flip against the base 21 and lean on the first leaning portion 216 of the base 21 after flipping, so that the flipped carrying body 23 is perpendicular to the base 21. Referring to FIG. 5C, then the retaining body 22 is also pulled to flip against the carrying body 23 and lean on the second leaning portion 236 of the carrying body 23 in a perpendicular manner as shown in FIG. 5D when the aforesaid movements are finished. After the carrying body 23 has finished flipping against the base 21 it exposes the carrying plane 232; and the retaining body 22 also exposes the confining plane 221 after flipping against the carrying body 23 is finished. Thereby the base 21, carrying plane 232 and confining plane 221 jointly form the housing space 5 to hold and confine the beverage container 4.

When to return the beverage container holding rack 2 to the folding and storage state is desired, move and flip the retaining body 22 against the carrying body 23 to stack over thereof, then move and flip the carrying body 23 against the base 21 to stack over thereof, then all the pieces are compacted in the original folding and storage state.

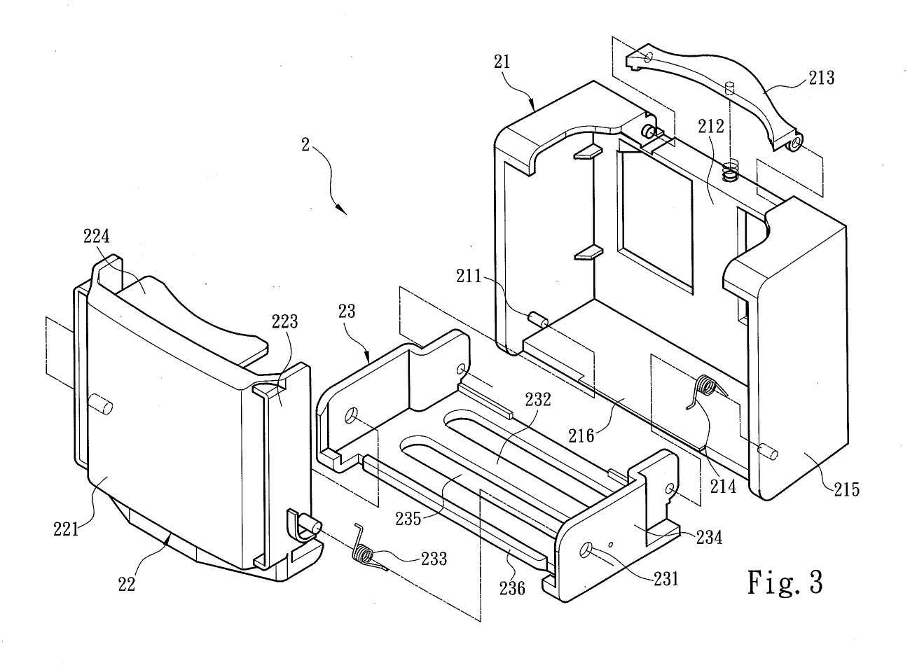

Please refer to FIGS. 3 and 5A for another embodiment of the invention. In order to make the beverage container holding rack 2 in the folding and storage state in normal conditions with the retaining body 22 interposed between the base 21 and carrying body 23, the base 21 further has a first latch portion 213 connected to the assembly portion 212, and the retaining body 22 has a second latch portion 222 corresponding to and latchable with the first latch portion 213. Thereby when the beverage container holding rack 2 is in the folding and storage state, the first and second latch portions 213 and 222 are latched together. When holding the beverage container 4 is desired, the first latch portion 213 is disengaged from the second latch portion 222 to form the housing space 5. The process is same as previously discussed, thus details are omitted herein.

In yet another embodiment, referring to FIG. 3, the first pivotal portion 211 is coupled with a first elastic element 214 to provide an elastic action force for the carrying body 23 hinged on the base 21, thereby the carrying body 23 can automatically flip against the base 21 upon receiving the elastic action force from the first elastic element 214. The second pivotal portion 231 also has a second elastic element 233 located thereon to provide same effect as the first elastic element 214. Details also are omitted. This embodiment can be implemented by incorporating with the previous embodiment, in which when the first latch portion 213 is disengaged from the second latch portion 222 under an external force, the carrying body 23 and retaining body 22 receive the elastic action forces from the first and second elastic elements 214 and 233 and flip automatically to form the housing space 5 quickly.

In yet another embodiment of the invention, referring to FIGS. 2 and 3, in order to securely hold the beverage container 4 in the housing space 5, the base 21 has a first barrier wall 215 extended into the housing space 5, and the carrying body 23 has a retaining wall 234 extended into the housing space 5, and the retaining body 22 has a second barrier wall 223 extended into the housing space 5. Thereby the beverage container 4 held in the housing space 5 is confined securely by the first barrier wall 215, second barrier wall 223 and retaining wall 234. While this embodiment contains all the first barrier wall 215, second barrier wall 223 and retaining wall 234, in practice they do not have to exist at the same time. By providing one or two of them can substantially achieve the result desired.

These days beverages are often provided in a cold drink fashion. When the cold drink is exposed to the atmosphere for a prolonged period of time moisture in the air is condensed to form water drops on the surface of the beverage container 4. To address this phenomenon the present invention provides another embodiment in which the carrying plane 232 has at least one drain port 235 to discharge water drops condensed on the surface of the beverage container 4 holding cold drink.

Due to the beverage container 4 can be formed in different sizes, the present invention also provides another embodiment with the beverage container holding rack 2 to accommodate different sizes of beverage containers 4. In this embodiment, the confining plane 221 of the retaining body 22 is connected to an elastic butting plate 224 which can flip against the confining plane 221. When the beverage container 4 is formed at a smaller diameter than that of the housing space 5, it can be butted by the elastic butting plate 224 and securely held in the housing space 5 without slipping out. In the event that the beverage container 4 is formed at a diameter same as the housing space 5, when the beverage container 4 is loaded, the elastic butting plate 224 is pushed and flipped towards the confining plane 221 in parallel therewith. The elastic butting plate 224 previously discussed merely serves for illustrative purpose and is not the limitation of the invention.

As a conclusion, the present invention provides a furniture structure to hold beverage containers. It includes a beverage container holding rack that is constructed with various elements pivotally connected to allow the carrying body to flip against the base and allow the retaining body to flip against the carrying body, thereby the structural states of the beverage container holding rack can be changed after flipping of the constructed elements to meet use requirements. Compared with the conventional beverage container holding rack made in only one fixed structure and not changeable, the beverage container holding rack of the invention can be formed in a folding and storage state to overcome the storage problem of the furniture body that occurs to the conventional beverage container holding rack.

While the preferred embodiments of the invention have been set forth for the purpose of disclosure, they are not the limitations of the invention, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A furniture structure to hold beverage containers, comprising:
a furniture body including at least one support portion and an assembly hole formed on the at least one support portion;
a beverage container holding rack relative to the at least one support portion and including a base, a retaining body and a carrying body hinged on the base and the retaining body, the base including a first pivotal portion connected to the carrying body and an assembly portion corresponding to the assembly hole, the carrying body including a second pivotal portion connected to the retaining body and a carrying plane exposed upon flipping against the base, the retaining body including a confining plane exposed upon flipping against the carrying body; the base, the carrying plane and the confining plane jointly forming a housing space to hold a beverage container; and
a fastening element which is fastened to the assembly hole and includes a fastening portion on one side opposing to the assembly hole to fasten to the assembly portion.

2. The furniture structure of claim 1, wherein the base includes a first latch portion connected to the assembly portion, the retaining body including a second latch portion corresponding to and latchable with the first latch portion.

3. The furniture structure of claim 1, wherein the first pivotal portion includes a first elastic element to provide an elastic action force for the base.

4. The furniture structure of claim 1, wherein the second pivotal portion includes a second elastic element to provide an elastic action force for the carrying body.

5. The furniture structure of claim 1, wherein the base includes a first barrier wall extended into the housing space.

6. The furniture structure of claim 1, wherein the carrying body includes a retaining wall extended into the housing space.

7. The furniture structure of claim 1, wherein the retaining body includes a second barrier wall extended into the housing space.

8. The furniture structure of claim 1, wherein the carrying plane includes at least one drain port.

9. The furniture structure of claim 1, wherein the retaining body includes an elastic butting plate connected to the confining plane.

10. The furniture structure of claim 1, wherein the base includes a first leaning portion leaned by the carrying body to prohibit the carrying body from flipping, the carrying body including a second leaning portion leaned by the retaining body to prohibit the retaining body from flipping.

11. The furniture structure of claim 1, wherein the fastening portion of the fastening element is a dovetail groove and the assembly portion coupled with the fastening portion is a dovetail.
